(19) United States
(12) Patent Application Publication
(10) Pub. No.: US 2007/0018580 A1
(43) Pub. Date: Jan. 25, 2007

(54) Lamp for a motor vehicle headlight

(75) Inventors: Lukas Kupper, Aachen (DE); Benno Spinger, Aachen (DE); Josephus Christiaan Maria Hendricx, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/568,014

(22) PCT Filed: Aug. 4, 2004
(86) PCT No.: PCT/IB04/51387

§ 371 Date: Feb. 10, 2006

(30) Foreign Application Priority Data
Aug. 15, 2003 (EP) 03102556.2

(51) Int. Cl. H01J 61/30

(52) U.S. Cl. 313/634; 313/110; 313/113; 313/573

(57) ABSTRACT

A lamp (1, 11, 14, 17) for a motor vehicle headlight is described. The lamp (1, 11, 14, 17) comprises a bulb (3) surrounding a light source (4) and a lamp base (2) arranged at an end of the bulb (3) and serving to support the lamp (1, 11, 14, 17) inside a reflector (20) of the headlight. At least one lens structure (7, 12, 15, 18) is present in or at an upper side (O) and/or lower side (U) of the bulb (3). This lens structure (6, 12, 15, 18) is constructed such that at least a portion of the light radiated by the light source (4) in the direction of a region of the reflector (20) close to the lamp base is redirected into a region of the reflector lying farther to the front.

The invention relates to a lamp for a motor vehicle headlight and to a motor vehicle headlight with such a lamp.

It is a basic requirement for practically all motor vehicle headlights that as good as possible an illumination of the traffic space should be achieved by the headlight so as to afford the driver of a vehicle a good view on the one hand, and on the other hand that dazzling of the oncoming traffic should be avoided so as not to bring the oncoming traffic into danger. To exclude dazzling of the oncoming traffic with certainty, accordingly, a so-called bright-dark boundary or cut-off has been defined for the low-beam function in respective standards. It is to be heeded in the construction of lamps and headlights and in the installation and adjustment of the headlights in the vehicle that only the traffic space below this bright-dark cut-off is illuminated. The bright-dark cut-off is observed in many cases by a suitable shading of the dark region by means of suitably positioned and shaped screen caps or diaphragms in the lamp itself or in the headlight. Furthermore, a redistribution of the light can be achieved also by means of optical elements in the headlight glass such that no light is radiated into the dark region above the bright-dark cut-off. The light radiated laterally from the lamp, i.e. issuing from the horizontally mutually opposed side faces in the incorporated state of the lamp, is usually imaged into the region immediately below the bright-dark cut-off in both systems. The light radiated upwards from the lamp, however, is reflected downwards into the low-beam region, and the light radiated downwards from the lamp is radiated into the lateral region, mainly on the left-hand side in the case of a headlight for right-hand traffic, through co-operation between the headlight reflector and further usual optical elements in the headlight glass.

The lamp and the headlight should be constructed such that as much light as possible is imaged into the allowed region very close to and below the bright-dark cut-off line so as to achieve as good as possible an illumination of the traffic space within the limits given by the bright-dark cut-off, in particular also as far as possible in front of the vehicle. Special constructions of the headlight reflector and/or of the headlight glass, in particular in conjunction with lamps specially constructed for the respective headlight, are capable of achieving a redistribution of the light such that the region immediately below the bright-dark cut-off is illuminated even more strongly. Unfortunately, however, additional conditions for optimizing the radiation behavior of the headlight also impose additional boundary conditions with respect to the design of the headlight and to the integration of the headlight into a given design of a motor vehicle front. In addition, such an optimization strategy would have the result that different lamp types were necessary for a greater number of different headlights, which would in the end lead to higher storage costs for replacement lamps at the suppliers' and which would have the additional result that it can no longer be ensured to the same degree that a suitable replacement lamp will always be quickly available.

It is an object of the present invention to provide a lamp for a motor vehicle headlight by means of which a better illumination of the traffic space in the allowed region immediately below the bright-dark cut-off can be achieved substantially independently of the exact construction of the headlight in which the lamp is incorporated.

This object is achieved by means of a lamp for a motor vehicle headlight which comprises a bulb enclosing a light source, a lamp base arranged at one end of the bulb for retaining the lamp inside a reflector of the headlight, and at least one lens structure arranged in or at an upper side and/or lower side of the bulb, which lens structure is constructed such that at least a portion of the light radiated from the light source in the direction of a region of the reflector close to the lamp base is redirected into a reflector region lying further to the front. The terms “upper side” and “lower side” of the lamp here relate to the usual position of the lamp as incorporated in a motor vehicle headlight. Similarly, the directional indications “front” and “rear”, etc. are to be understood in this sense.

It is utilized here that the image of the light source reflected into the traffic space from the regions of the reflector close to the lamp base is substantially larger than the image reflected from the regions lying further forward in the reflector. The redistribution of the light radiated in the direction of the reflector surface close to the lamp base into the front reflector regions accordingly automatically achieves that a larger proportion of the light reaches a central region close to the bright-dark cut-off, so that the luminous intensity here is increased. The light redirected into the front outermost reflector segments is accordingly incident in the traffic space on the farther traffic regions more important for the driver close to the bright-dark cut-off. Without this redirecting action of the lens structures, the light would also be imaged partly into the traffic spaces close to the vehicle. Light in the traffic spaces close to the vehicle, however, is not so relevant to the driver's safety because the reaction time is usually insufficient for reacting adequately to visually perceived dangers in this traffic region. More light in farther removed traffic regions, by contrast, provides an easier and earlier recognition of possible hazards, so that a longer reaction time is available to the driver. Given the same total quantity of light, therefore, a better illumination of the traffic space is achieved, while at the same time the anti-dazzling condition is complied with in that the bright-dark cut-off is observed. It is not necessary here to change the headlight itself, in particular the reflector, the headlight glass, the lampholder, or other components, by special measures. It suffices to insert a lamp according to the invention in a conventional headlight so as to obtain the advantageous effect.

The dependent claims relate to respective particularly advantageous embodiments and further implementations of the invention.

The lens structure may be realized in a variety of manners in principle. In one embodiment, for example, the lens structure comprises a concave lens which diverts the light into the desired reflector regions.

Alternatively or additionally, the lens structure may also comprise a prism. In a particularly preferred embodiment, the lens structure comprises an array of prisms, which prisms form, for example, a kind of Fresnel lens structure, so that the envisaged redirection of the light beams from the light source into the desired reflector regions is achieved.

To achieve the desired redistribution of the light in the region of the reflector close to the lamp base towards the reflector regions lying farther to the front, it suggests itself to arrange the lens structure such that it comprises at least an outer boundary surface arranged at the upper side or lower side of the bulb and directed obliquely to the rear in the direction of the lamp base. Light rays passing through the bulb will then be suitably diffracted at this boundary surface, so that the light is directed away from the lamp base in forward direction.

Such a lens structure can only be arranged at the upper side of the lamp, so that only the light radiated in upward direction in the reflector is redirected, which light is imaged by the reflector directly downwards into the traffic space. It is alternatively or additionally also possible, however, to provide suitable lens structures on the lower side of the lens so as to center the light radiated mainly into the lateral region of the traffic space also more strongly, so that again the brightness in the region below the bright-dark cut-off is increased. In a preferred modified embodiment, the lens structures according to the invention are present only at the surface and/or the lower side of the lamp, particularly preferably both below and above. In another modification, the lamp has lens structures also at the other surfaces, for example laterally or obliquely upwards or downwards.

The lens structure should then preferably be arranged substantially in a region of the bulb at the lamp base side, as viewed from the light source, so that predominantly only the light radiated into the reflector to the rear in the direction of the lamp base or obliquely in the direction of the lamp base passes through the lens structure, whereas the light radiated by the light source in forward direction is not redirected by the lens structure.

It is highly preferable that the lens structure extends from a rear end of the bulb at the lamp base side along a longitudinal bulb axis in the direction of a front end of the bulb at least up to a central region of the light source. This ensures that, for example, the entire quantity of light radiated from the center of the light source towards the rear along the longitudinal bulb axis passes through the lens structure in upward or downward direction and is thus redirected.

The lens structures are preferably integrated in the bulb by means of a suitable shaping of the bulb wall. They may be shaped simultaneously with the manufacture of the bulb—for example while the material is still in the liquid or plastic state—or they may be formed after bulb manufacture, for example by a suitable grinding of the outer side of the bulb. Alternatively, however, separately manufactured lenses or lens structures may be used, which are provided against the bulb wall, for example in an adhesion process.

The invention may be implemented with a wide variety of lamp types.

In a preferred embodiment, the lamp comprises a filament, for example an incandescent coil, as its light source. A typical example of such lamps is formed by halogen lamps such as the familiar H4 lamp. Such lamps generally comprise only one bulb, usually a quartz bulb, which directly surrounds the filament, but at a certain distance to the filament. The lens structures will then be preferably formed by the special shaping of the upper or lower side of this bulb.

In another preferred embodiment, the lamp is a gas discharge lamp. Typical gas discharge lamps are, for example, the so-termed HID (High Intensity Discharge) lamps such as, for example, high-pressure sodium lamps, or so-termed MPXL (Micro Power Xenon Light) lamps. Such lamps usually comprise a discharge vessel consisting of an inner bulb, usually a quartz bulb, which is filled with an inert gas. Electrodes extending in longitudinal lamp direction project into the inner bulb from mutually opposed ends so as to end at a certain distance from one another. After ignition by means of a high voltage applied to the electrodes, a discharge arc or luminous arc establishes itself between the electrodes, which arc is used as a light source. Usually, the inner bulb of a gas discharge lamp with the light source present therein is surrounded by an outer bulb, which is usually also made from quartz glass and serves inter alia for screening the UV radiation. It suggests itself in such gas discharge lamps to integrate the lens structures in the upper and/or lower side of the outer bulb or to arrange them against this bulb.

Alternatively, however, the inner bulb may be provided with the relevant lens structures. This has the advantage that the lens structures are positioned closer to the light source and accordingly are more efficient. The disadvantage is, however, that the introduction of such lens structures in or at the inner bulb is technically more complicated and more expensive, and that in addition each change in the geometry of the inner bulb at the same time also leads to changes in other lamp parameters such as, for example, the temperature distribution in the inner bulb. This in its turn has an effect on the formation of the discharge arc and thus on the light distribution. In contrast thereto, the provision of lens structures in the outer bulb is comparatively simple and inexpensive and has no effect on the radiation and efficacy of the light source itself.

The invention may indeed also be implemented with gas discharge lamps having only a single bulb or with filament lamps having an additional outer bulb. Furthermore, it is also possible in the case of lamps having an inner and an outer bulb to arrange suitably co-operating lens structures at the inner bulb and at the outer bulb.

The invention is particularly suitable for use with lamps having a low-beam function, because it is in particular with the low beam that the problems arise in trying to achieve as strong as possible an illumination below a given bright-dark cut-off. This is not to say, however, that the lamp cannot be also used for other purposes in other motor vehicle luminaires.

The lamp may in principle comprise more than one light source. In such a case the lens structure is preferably arranged such that at least the light radiated by one of the light sources in the direction of the reflector region close to the lamp base is redirected towards a reflector region lying farther to the front. An example of this is a usual H4 lamp, which comprises two filaments, one filament serving for the low-beam function and the other filament for the high-beam function. In this case the lens structures may be provided such that, for example, only the light from the low-beam light source is suitably redirected so as to achieve the desired illumination close to the bright-dark cut-off.

The lamp according to the invention may be used without modifications both in headlights for right-hand traffic and for left-hand traffic without problems, unless it provides other additional elements specially designed for right-hand or left-hand traffic.

The invention will be explained in more detail below with reference to embodiments and to the appended drawing, in which:

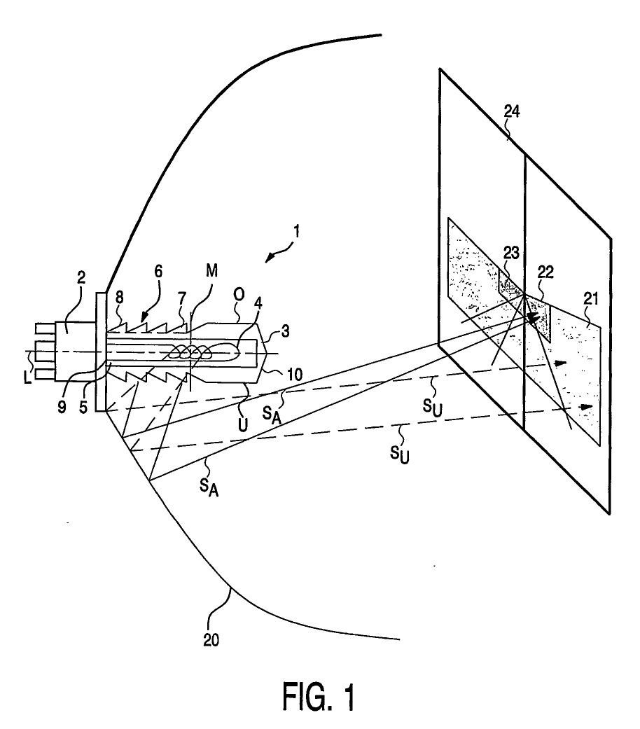

FIG. 1 is a longitudinal sectional view of a first embodiment of a lamp according to the invention in a reflector (indicated diagrammatically only), with a diagrammatic representation of the effect of the lens structure on the illumination in the traffic space,

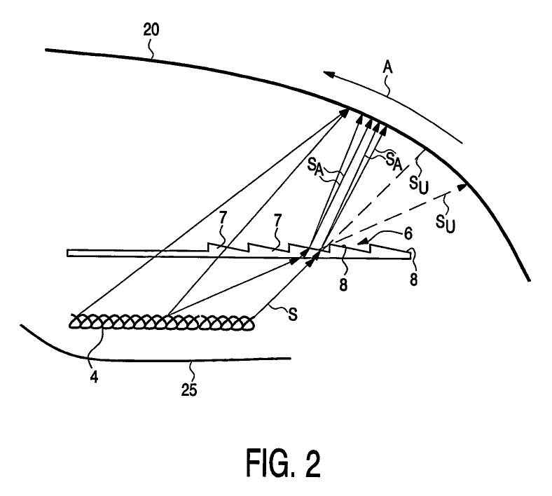

FIG. 2 shows a lens structure of FIG. 1 in more detail,

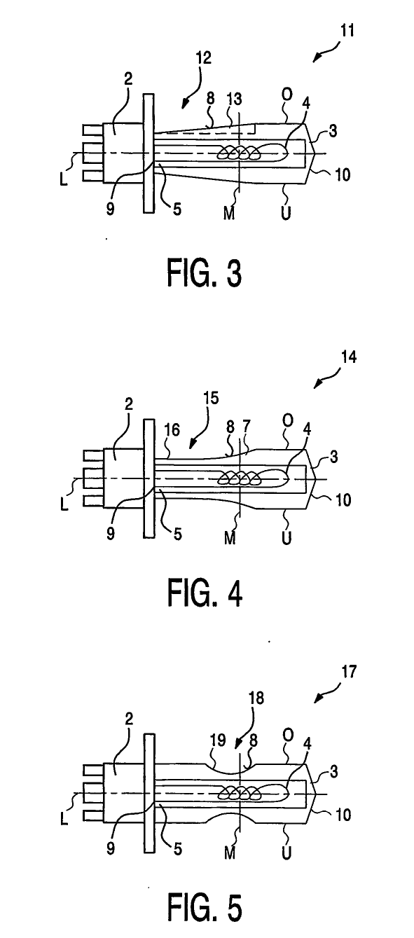

FIG. 3 is a longitudinal sectional view of a lamp according to the invention in a second embodiment,

FIG. 4 is a longitudinal sectional view of a lamp according to the invention in a third embodiment,

FIG. 5 is a longitudinal sectional view of a lamp according to the invention in a fourth embodiment,

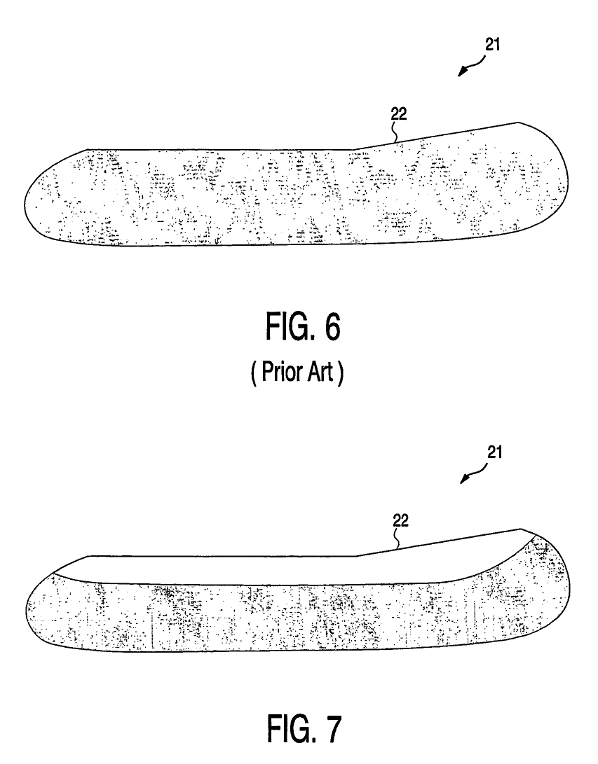

FIG. 6 diagrammatically shows the illumination of the traffic space by means of a lamp according to the prior art, and

FIG. 7 diagrammatically shows the illumination of the traffic space by means of a lamp according to the invention.

The lamps shown in FIGS. 1 to 5 are all filament lamps which are predominantly used in the field of motor vehicle headlights at present. The invention, however, may be equally well be used for other lamp types, in particular gas discharge lamps.

FIG. 1 is a diagrammatic longitudinal view of a filament lamp 1 comprising a bulb 3, usually made of quartz glass or the like, which is fastened to a lamp base 2 at its rear end 9. An evacuated hollow space 5, in which a coil 4 is arranged as the light source 4, is present in the bulb 3. The lamp base 2 has plug contacts at its rear end in a usual manner, via which a voltage obtained from the car circuit is applied to the coil 4 so as to cause it to glow.

The bulb 3 is a substantially cylindrical bulb 3 extending along and around a longitudinal bulb axis L and closed off at the front end 10 opposed to the base end 9 by means of an end wall which has a conical external shape with a very obtuse cone angle. In principle, however, the bulb 3 may have substantially any other shape as desired.

A lens structure 6 is arranged at the upper and/or lower side of the bulb 3 of the lamp 1. In the embodiment shown in FIG. 1, this is a kind of Fresnel lens structure 6 with an array of prisms comprising a plurality of individual prisms 7. The individual prisms 7 each have a boundary surface 8 extending on the outside obliquely in the direction of the lamp base 2. The Fresnel lens structure 6 thus has the effect diagrammatically shown, i.e. that light rays S directed from the light source 4 into the regions of the reflector 20 close to the lamp base are diverted at the boundary surfaces 8 of the prisms such that the diverted light rays S_{A} are incident in a region of the reflector 20 lying farther to the front. Without the prisms 7, the unaffected light rays Su would follow the paths indicated by broken lines and would be incident farther to the rear in the reflector 20.

FIG. 2 shows this effect of the Fresnel lens structure 6 once more on an enlarged scale. Only the portion of the bulb 3 comprising the lens structure 6 is shown here, together with the filament 4 and a screen cap 25, such as the one usual, for example, in H4 luminaires for providing a reliable observance of the bright-dark cut-off. This screen cap 25 is shaped such that the bright-dark cut-off follows the desired shape: obliquely to top left in the case of right-hand traffic and obliquely to top right in the case of left-hand traffic.

As is apparent from FIG. 2, the light rays S radiated from the rear region of the coil 4 towards the rear are diffracted to the front at the boundary surfaces 8 of the individual prisms 7 of the lens structure 6, so that the light rays S_{A} follow the paths of the solid lines outside the bulb 3. Without said prisms 7, the light rays S_{A} would follow the broken lines. On average, therefore, the diversion A of the light takes place in a direction indicated by the arrow extending outside the reflector 20.

FIG. 1 also diagrammatically shows the arrangement of said lamp 1 in a usual reflector 20 of a motor vehicle headlight, as well as the redirection of the light rays S_{A} originating from the lamp 1, i.e. the light source 4 thereof, by the reflector 20 into the traffic space 21. The traffic space 21 is shown here in a sectional plane 24 at a distance in front of the reflector 20. The illuminated traffic space 21 is bounded in upward direction by the bright-dark cut-off 22, above which no light is allowed to be radiated so as to avoid dazzling of the oncoming traffic. The bright-dark cut-off extends obliquely upwards to the left because this is a headlight or a lamp for right-hand traffic.

As is clear from FIG. 1, the light rays S_{A} thus redirected are guided more strongly into a central region 23 along the bright-dark cut-off 22 than is the case for non-diverted light rays Su represented by the broken-line arrows.

The effect that the light of the light source 4 radiated into the region of the reflector 20 close to the lamp base is distributed farther away in the traffic space 21 and that the light reflected into the reflector regions farther away from the lamp base 2 is centered more in the central region below the bright-dark cut-off 22 follows from the fact that the object distance, i.e. the distance between the light source 4 and the relevant portion of the reflector surface reflecting the incident light into the traffic space 21, is greater for the reflector regions lying farther forward than in the regions close to the lamp base. Since the image of the light source 4 becomes smaller with an increase in the object distance, this 5 automatically has the result that the forward regions of the reflector 2 far from the lamp base image the light source 4 smaller in the traffic space 21 and accordingly center the light more strongly than do the regions close to the lamp base.

FIGS. 3 to 5 show alternative embodiments for constructing the bulb 3 of the lamp 1 so as to achieve the envisaged effect.

In FIG. 3, the lens structure 12 of the lamp 11 is simply formed by one large prism 13. This prism is obtained in that the upper side O and the lower side U of the bulb wall conically approach one another towards the rear under formation of respective oblique boundary surfaces 8.

FIG. 4 shows a further embodiment of a lamp 14 with a lens structure 15 formed by a slightly concave lens 16 provided into the upper side as well as the lower side of the bulb 3. The upper side O and the lower side U of the bulb 3 are shaped such that the bulb 3 has a thicker wall in the front region than in the rear region close to the lamp base, both at the upper side and at the lower side. The transition between the two regions of different wall thicknesses is present approximately in the central region of the coil 4, i.e. viewed from the front of the bulb 3 just behind a plane M through the center of the coil 4 and extending perpendicularly to the longitudinal bulb axis L. This transition is formed as a slightly concave outer boundary surface 8 of the bulb 3 extending obliquely towards the rear.

FIG. 5 shows a simpler embodiment with a simple concave lens both in the upper and in the lower side, slightly behind the central plane M of the filament 4.

It is common to all embodiments that they have a boundary surface 8 extending obliquely to the rear towards the lamp base 2. The arrangement of the lens structure 6, 12, 15, 18 substantially behind the central plane M of the filament 4 ensures that the light rays directed towards the front are not affected by the lens structure 6, 12, 15, 18.

FIGS. 6 and 7 diagrammatically show once more the illumination of the traffic space 21 by means of a prior-art lamp (FIG. 6) and by means of a lamp according to the invention (FIG. 7) for comparison purposes. As is apparent from these Figures, the redirectioning of the light according to the invention from the reflector regions close to the lamp base into the reflector regions remote from the lamp base achieve a better illumination of the traffic region of interest close to the bright-dark cut-off 22, given the same quantity of light.

It is pointed out once more, finally, that the lamps 1, 11, 14, 17 shown in the Figures and discussed in the description are merely examples which may be modified in a wide variety of ways by those skilled in the art without departing from the scope of the invention. Thus, in particular, the lens structures may have different shapes in detail so as to achieve the desired effects. Similarly, the individual features of the various embodiments may be combined so as to form new embodiments, for example lens structures with combinations of prisms and concave lenses and/or further suitable lens elements. It is furthermore pointed out for completeness's sake that the use of the indefinite article “a” and “an” does not exclude the presence of a plurality of the respective element, and that the use of the verb “comprise” does not exclude the existence of further elements.

1. A lamp (1, 11, 14, 17) for a vehicle headlight
with a bulb (3) surrounding a light source (4),
with a lamp base (2) arranged at an end of the bulb (3) for supporting the lamp (1, 11, 14, 17) within a reflector (20) of the headlight,
and with at least one lens structure (6, 12, 15, 18) present in or at an upper side (O) and/or lower side (U) of the bulb (3), which structure is arranged such that at least a portion of the light radiated by the light source (4) in the direction of a region of the reflector (20) close to the lamp base is redirected into a reflector region lying farther to the front.

2. A lamp as claimed in claim 1, characterized in that the lens structure (15, 18) comprises a concave lens (16, 19).

3. A lamp as claimed in claim 1, characterized in that the lens structure (6, 12) comprises a prism (7, 13).

4. A lamp as claimed in claim 3, characterized in that the lens structure (6) comprises an array of prisms.

5. A lamp as claimed in claim 1, characterized in that the lens structure (6, 12, 15, 18) comprises at least an outer boundary surface (8) arranged at the upper side (0) or lower side (U) of the bulb (3) and directed obliquely to the rear in the direction of the lamp base (2).

6. A lamp as claimed in claim 1, characterized in that the lens structure (6, 12, 15, 18), as viewed from the light source (4), is positioned essentially in a region of the bulb (3) at the lamp base side.

7. A lamp as claimed in claim 1, characterized in that the lens structure (6, 12, 15) extends from a rear end (9) of the bulb (3) at the lamp base side along a longitudinal bulb axis (L) in the direction of a front end (10) of the bulb (3) at least up to a central region of the light source (4).

8. A lamp as claimed in claim 1, characterized in that the lens structure (6, 12, 15, 18) is at least partly integral with the bulb.

9. A lamp as claimed in claim 1, characterized in that the lamp (1, 11, 14, 17) comprises a filament (4) as its light source (4).

10. A lamp as claimed in claim 1, characterized in that the lamp comprises a discharge arc as its light source.

11. A lamp as claimed in claim 1, characterized in that the lamp comprises a plurality of light sources, the lens structure being arranged such that at least a portion of the light radiated by one of the light sources in the direction of the region of the reflector close to the lamp base is redirected into a region of the reflector lying farther to the front.

12. A lamp as claimed in claim 1, characterized in that the lamp (1, 11, 14, 17) has a low-beam function.

13. A motor vehicle headlight with a reflector (20) and a lamp (1, 11, 14, 17) arranged therein as claimed in claim 1.
